(19) United States
(12) Patent Application Publication
(10) Pub. No.: US 2020/0393847 A1
(43) Pub. Date: Dec. 17, 2020

(54) DYNAMIC VEHICLE NAVIGATION BASED ON LEADER FOLLOWER SCHEME

(71) Applicant: GM GLOBAL TECHNOLOGY OPERATIONS LLC, Detroit, MI (US)

(72) Inventors: Suchinder K. Govindan, Farmington Hills, MI (US); David A. Adams, Troy, MI (US)

(21) Appl. No.: 16/443,320

(22) Filed: Jun. 17, 2019

(51) Int. Cl. G05D 1/02; G01C 21/36; G08G 1/00

(52) U.S. Cl. CPC G05D 1/0276; G01C 21/3664; G08G 1/22; G05D 2201/0213; G05D 1/0231; G05D 1/0212; G05D 1/0257

(57) ABSTRACT

A system and method of providing dynamic vehicle navigation information to a follower vehicle based on a leader vehicle location of a leader vehicle. The method includes: establishing a communication link between a first personal mobile device and a second personal mobile device; after establishing the communication link, obtaining leader vehicle identification information and follower vehicle identification information, wherein the leader vehicle identification information is used to identify a vehicle as the leader vehicle, and wherein the and follower vehicle identification information is used to identify a vehicle as the follower vehicle; periodically obtaining the leader vehicle location of the leader vehicle; and causing a follower vehicle device to be periodically provided dynamic vehicle navigation information based on the leader vehicle location, wherein the dynamic vehicle navigation information includes directions so that the follower vehicle at least partially follows the leader vehicle.

### INTRODUCTION

The present invention relates to providing dynamic vehicle navigation information to a follower vehicle based on a location of a leader vehicle.

Vehicles include hardware and software capable of obtaining and processing various information, including information that is obtained by vehicle system modules (VSMs). The vehicles can also include hardware and/or software for purposes of vehicle navigation. For example, a user may input a destination, and then directions can be provided to the vehicle.

### SUMMARY

In some instances, a user may desire to follow a vehicle or mobile device that changes its position over time. Thus, there is a need for a system and method in which a follower vehicle or vehicle device can be provided dynamic vehicle navigation information pertaining to the location and/or path of a leader vehicle that enables the follower vehicle to follow the leader vehicle. According to various embodiments, the method and system provided herein aims to accomplish this.

According to one aspect of the invention, there is provided a method of providing dynamic vehicle navigation information to a follower vehicle based on a leader vehicle location of a leader vehicle. The method includes: establishing a communication link between a first personal mobile device and a second personal mobile device, wherein the first personal mobile device is associated with the leader vehicle and the second personal mobile device is associated with the follower vehicle; after establishing the communication link between the first personal mobile device and the second personal mobile device, obtaining leader vehicle identification information and follower vehicle identification information, wherein the leader vehicle identification information is used to identify a vehicle as the leader vehicle, and wherein the and follower vehicle identification information is used to identify a vehicle as the follower vehicle; periodically obtaining the leader vehicle location of the leader vehicle; and causing a follower vehicle device to be periodically provided dynamic vehicle navigation information based on the leader vehicle location, wherein the dynamic vehicle navigation information includes directions so that the follower vehicle at least partially follows the leader vehicle.

According to various embodiments, this method may further include any one of the following features or any technically-feasible combination of some or all of these features:
the dynamic vehicle navigation is provided to the follower vehicle during a vehicle trip in which the leader vehicle and the follower vehicle are participating vehicles, wherein the periodically obtaining step and the causing step are carried out periodically until it is determined that the vehicle trip has ended;
the method further comprises sending the leader vehicle location to the follower vehicle device, wherein the follower vehicle device is configured to display a leader vehicle location indicator on a geographical map of the surrounding area of the follower vehicle device so as to enable a user at the follower vehicle device to track the leader vehicle;
obtaining the leader vehicle location comprises obtaining the leader vehicle location from the first personal mobile device or from a leader vehicle device installed in the leader vehicle, and wherein the follower vehicle device is the second personal mobile device or is a different device installed in the follower vehicle;
the first personal mobile device includes a first vehicle user application and the second personal mobile device includes a second vehicle user application, and wherein the first vehicle user application and/or the second vehicle user application provide a graphical user interface (GUI) that enables a user to search for other devices participating or seeking to participate in a vehicle trip;
the user provides input into the first vehicle user application and/or the second vehicle user application, and wherein the input specifies which vehicle is to be the leader vehicle.
the leader vehicle location is periodically obtained at the leader vehicle using a global navigation satellite system (GNSS) receiver and then sent to a first remote computer from the vehicle using a wireless carrier system;
the leader vehicle location is used by a second remote computer to obtain the dynamic vehicle navigation information, and wherein the second remote computer is either the first remote computer or another remote computer;
the leader vehicle location is sent from the first remote computer to the follower vehicle device, wherein, after receiving the leader vehicle location, the follower vehicle device sends the leader vehicle location to the second remote computer, and wherein, in response to receiving the leader vehicle location, the second remote computer sends the dynamic vehicle navigation information to the follower vehicle device;
the follower vehicle is an autonomous vehicle (AV), and wherein the follower vehicle uses the dynamic vehicle navigation information to carry out one or more AV functions so as to cause the follower vehicle to follow the leader vehicle location based on the dynamic vehicle navigation information;
the follower vehicle includes one or more onboard vehicle sensors in the form of either a radar or lidar, wherein the follower vehicle captures sensor data from the one or more onboard vehicle sensors, wherein the follower vehicle uses the sensor data to identify the leader vehicle and to determine the position of the leader vehicle relative to the follower vehicle, and wherein the position of the leader vehicle relative to the follower vehicle is used to carry out at least one of the one or more AV functions; and/or
the follower vehicle determines one or more trajectories based on the dynamic vehicle navigation information, and wherein the follower vehicle determines at least one of the one or more of AV functions based on the trajectories.

According to another aspect of the invention, there is provided a method of providing dynamic vehicle navigation information to a follower vehicle based on a leader vehicle location of a leader vehicle. The method includes: establishing a communication link between a first personal mobile device and a second personal mobile vehicle device, wherein the first personal mobile device includes a first vehicle user application and the second personal mobile device includes a second vehicle user application, and wherein the first vehicle user application and/or the second vehicle user application provide a graphical user interface (GUI) that enables a user to search for other devices participating or seeking to participate in a vehicle trip; obtaining input from one or more users of the first vehicle user application and/or the second vehicle user application, wherein the input specifies a first vehicle to be the leader vehicle and the input specifies a second vehicle to be the follower vehicle; sending the input to a first remote computer from the first vehicle user application and/or the second vehicle user application, wherein the remote computer causes the leader vehicle to periodically send the leader vehicle location to a second remote computer, wherein the second remote computer is either the first remote computer or another remote computer; and causing a follower vehicle device to be periodically provided dynamic vehicle navigation information based on the leader vehicle location, wherein the dynamic vehicle navigation information includes directions so that the follower vehicle at least partially follows the leader vehicle.

According to various embodiments, this method may further include any one of the following features or any technically-feasible combination of some or all of these features:
the first vehicle user application permits a first user to login to a first account associated with the first vehicle and the second vehicle user application permits a second user to login to a second account associated with the second vehicle;
the first vehicle user application and the second vehicle user application identify each participating vehicle of a plurality of participating vehicles, and wherein the plurality of participating vehicles includes the leader vehicle and the follower vehicle;
the plurality of participating vehicles includes a plurality of follower vehicles, and wherein the causing step includes causing each of the plurality of follower vehicles to be periodically provided the dynamic vehicle navigation information based on the leader vehicle location; and/or
for each of the follower vehicles, the dynamic vehicle navigation information includes providing a series of waypoints based on the follower vehicle location and the leader vehicle location.

According to yet another aspect of the invention, there is provided a method of providing dynamic vehicle navigation information to a follower vehicle based on a leader vehicle location of a leader vehicle. The method includes: establishing a communication link between a first personal mobile device and a second personal mobile vehicle device, wherein the first personal mobile device includes a first vehicle user application and the second personal mobile device includes a second vehicle user application, and wherein the first vehicle user application and/or the second vehicle user application provide a graphical user interface (GUI) that enables a user to search for other devices participating or seeking to participate in a vehicle trip; obtaining input from one or more users of the first vehicle user application and/or the second vehicle user application, wherein the input specifies a first vehicle to be the leader vehicle and the input specifies a second vehicle to be the follower vehicle; sending the input to a first remote computer from the first vehicle user application and/or the second vehicle user application, wherein the remote computer causes the leader vehicle to periodically send the leader vehicle location to a second remote computer, wherein the second remote computer is either the first remote computer or another remote computer; and causing the follower vehicle to autonomously follow the leader vehicle based on sensor data from one or more autonomous vehicle (AV) sensors, wherein the follower vehicle follows the leader vehicle by tracking the leader vehicle using the sensor data to obtain the leader vehicle location, wherein the sensor data pertains to an area in front of the follower vehicle, and wherein the sensor data is used to obtain dynamic vehicle navigation information that then is used by the follower vehicle for carrying out one or more AV functions so as to at least partially follow the leader vehicle.

According to various embodiments, this method may further include any one of the following features or any technically-feasible combination of some or all of these features:
the follower vehicle determines one or more trajectories based on the sensor data, and wherein the follower vehicle determines at least one of the one or more of AV functions based on the trajectories; and/or
the follower vehicle is periodically provided a global navigation satellite system (GNSS) location of the leader vehicle, and wherein the dynamic vehicle navigation information or other dynamic vehicle navigation information is obtained based on the GNSS location of the leader vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of a vehicle electronics that can be included as a part of the leader vehicle of FIG. 1;

FIG. 3 is a block diagram depicting an embodiment of a vehicle electronics that can be included as a part of the follower vehicle of FIG. 1;

FIG. 4 is a flowchart of an embodiment of a method of providing dynamic vehicle navigation information to a follower vehicle based on a leader vehicle location of a leader vehicle;

FIG. 5 is a flowchart of an embodiment of a method of providing dynamic vehicle navigation information to a follower vehicle based on a leader vehicle location of a leader vehicle; and

FIG. 6 is a block diagram depicting an embodiment of a vehicle electronics that can be included as a part of the follower vehicle of FIG. 1.

### DETAILED DESCRIPTION

The system and method described below enables a follower vehicle to be provided dynamic vehicle navigation information that enables the follower vehicle to follow a leader vehicle. The dynamic vehicle navigation information can include or be based on a location of the leader vehicle (referred to as a “leader vehicle location”). The leader vehicle location can be determined at a leader vehicle device, which is a device that is carried by the leader vehicle, such as certain electronics of the leader vehicle or a personal mobile device associated with the leader vehicle. In some embodiments, a first personal mobile device that is associated with the leader vehicle and a second personal mobile device that is associated with a follower vehicle can establish a wireless connection through use of a vehicle user application. The vehicle user application can allow one or more users to configure a vehicle trip in which a follower vehicle is to follow a leader vehicle based on the dynamic vehicle navigation information. The vehicle user application can enable the user(s) to specify a particular vehicle as the leader vehicle or as a follower vehicle.

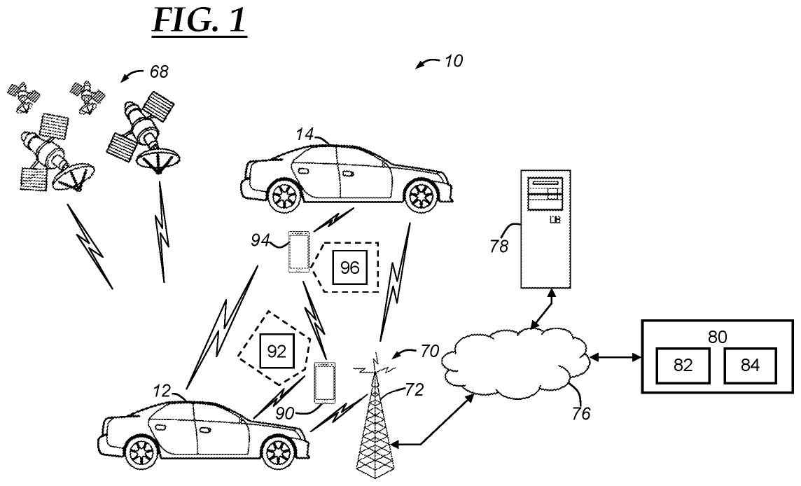

With reference to FIG. 1, there is shown an operating environment that comprises a communications system 10 and that can be used to implement the method disclosed herein. Communications system 10 generally includes a leader vehicle 12, a follower vehicle 14, a constellation of global navigation satellite system (GNSS) satellites 68, one or more wireless carrier systems 70, a land communications network 76, remote computer(s) 78, a vehicle backend services facility 80, a first personal mobile device 90, and a second personal mobile device 94. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed methods as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers.

Land network 76 may be a conventional land-based telecommunications network that is connected to one or more landline telephones and connects wireless carrier system 70 to vehicle backend services facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof

Remote computer(s) 78 can be one or more remote computers accessible via a private or public network such as the Internet. In one embodiment, each such remote computer 78 can be used for one or more purposes, such as for providing navigational services to one or more vehicles and/or other electronic network computing devices, including the leader vehicle 12, the follower vehicle 14, the first personal mobile device 90, and the second personal mobile device 94. Other such remote computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the leader vehicle 12, the follower vehicle 14, and/or the backend facility 80.

Vehicle backend services facility 80 is a backend facility and is located at a physical location that is located remotely from leader vehicle 12 and follower vehicle 14. The vehicle backend services facility 80 (or “backend facility 80” for short) may be designed to provide the vehicle electronics 20 (and/or the vehicle electronics of the follower vehicle 14) with a number of different system back-end functions through use of one or more electronic servers 82 and, in some cases, may provide navigation-related services to a plurality of vehicles. The vehicle backend services facility 80 includes vehicle backend services servers 82 and databases 84, which may be stored on a plurality of memory devices. Vehicle backend services facility 80 may include any or all of these various components and each of the various components can be coupled to one another via a wired or wireless local area network. The backend facility 80 may receive and transmit data via a modem connected to land network 76. Data transmissions may also be conducted by wireless systems, such as IEEE 802.11x, GPRS, and the like. Those skilled in the art will appreciate that, although only one backend facility 80 and one remote computer 78 are depicted in the illustrated embodiment, numerous remote facilities 80 and/or remote computers 78 may be used. Moreover, a plurality of backend facilities 80 and/or remote computers 78 can be geographically distributed and can each coordinate information and services with one another, as those skilled in the art will appreciate.

The servers 82 are computers or other computing devices that include at least one processor and that include memory. The servers 82 are located at the backed facility 80 and are an example of remote computers. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. This software may be stored in computer-readable memory and can be any suitable computer-readable medium, such as non-transitory, computer-readable memory. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and/or magnetic or optical disc drives. For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. The backend facility 80 can include a number of routers, modems, switches, or other network devices that can be used to provide networking capabilities, such as connecting with land network 76 and/or wireless carrier system 70.

Databases 84 can be stored on a plurality of memory, such as a powered temporary memory or any suitable non-transitory, computer-readable medium. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and/or magnetic or optical disc drives. In one embodiment, databases 84 include the geographical roadway information database; however, in other embodiments, the geographical roadway information database can be a part of or accessible by the remote computers 78. The geographical roadway information database includes geographical map information including geographical roadway map data that digitally represents geographical areas including roadways on the surface of earth. The geographical roadway map data includes data representing geographical regions and roadways among one or more geographical regions. The geographical roadway map data can include various additional information, such as roadway dimensions and geometries (i.e., information representing geographical areas in which roadways are located), roadway attributes (e.g., speed limit, permitted direction of travel, lane information, traffic signal information), roadway conditions (e.g., present or estimated traffic conditions, predicted and/or observed weather conditions along the roadway), and various other information. Any of the geographic roadway map data can be associated with geographical coordinates or other location-identifying information that can be used to tie the data to a particular geographical point or area. The geographical roadway map data can also include geographical or topographical map data that represents other features of the earth, such as altitude of the earth. Other information can be stored at the databases 84, including account information such as vehicle services subscriber information (e.g., credentials and authentication information), vehicle identifiers, vehicle transactional information, and other vehicle information.

The databases 84 can also store account information for users of various vehicles and/or vehicle user applications. In one embodiment, the databases 84 can store vehicle account information that associates a particular user with one or more particular vehicles, and which can be used to associate a particular device with a particular vehicle through a user logging into their account on the particular device through use of the vehicle user application. For example, a first user of the leader vehicle 12 can use their personal mobile device 90 to input a username and password (or other credentials) into a graphical user interface (GUI) of the vehicle user application (which is executed on the first personal mobile device 90). The vehicle user application can then verify the credentials by sending these credentials to a remote computer (e.g., servers 82, remote computers 78). The user and the user's vehicle can then be linked or associated with the first personal mobile device 90 and, in this example, the first personal mobile device 90 can then be considered a leader vehicle device. The same can be done for the second personal mobile device 94 with respect to the follower vehicle 14 and, in this example, the second personal mobile device 94 can then be considered a follower vehicle device.

The first personal mobile device 90 and the second personal mobile device 94 are each a mobile device and a short-range wireless communication (SRWC) device (i.e., a device capable of SRWC (e.g., Bluetooth™, Wi-Fi™)), and may each include: hardware, software, and/or firmware enabling cellular telecommunications and SRWC as well as other mobile device applications. The hardware of the personal mobile device 90 may comprise: a processor and memory for storing the software, firmware, etc. The processor and memory may enable various software applications, which may be preinstalled or installed by the user (or manufacturer). In one embodiment, both of the personal mobile devices 90, 94 include a vehicle user application 92, 96 that enables a vehicle user to communicate with the vehicle 12 (e.g., such as inputting route or trip parameters) and/or communicate with each other (i.e., communication between the first personal mobile device 90 and the second personal mobile device 94). Additionally, one or more applications may allow the user to connect with the backend facility 80 or call center advisors.

As used herein, a personal mobile device is a mobile device that is portable by a user, and where the portability of the device is at least partly dependent on the user, such as a wearable device (e.g., a smartwatch), an implantable device, or a handheld device (e.g., a smartphone, a tablet, a laptop). In many embodiments, the personal mobile device is a personal SRWC device. As used herein, a short-range wireless communications (SRWC) device is a device capable of SRWC. In one particular embodiment, either or both of the personal mobile devices 90, 94 can be a personal cellular SRWC device that includes a cellular chipset and/or cellular connectivity capabilities, as well as SRWC capabilities. Using a cellular chipset, for example, the personal mobile devices 90, 94 can connect with various remote devices, including the remote computers 78 and the servers 82 of the backend facility 80 via wireless carrier system 70 and/or land network 76.

The vehicle user application 92, 96 is an application that enables the user to configure or establish a vehicle trip, including one in which a follower vehicle follows a leader vehicle. In some embodiments, the vehicle user application 92, 96 can also enable the user to view information pertaining to the vehicle 12, 14. In one embodiment, the personal mobile devices 90, 94 are smartphones, and the vehicle user application 92, 96 can be downloaded by the user(s) through a digital distribution service or application, such as

Google P1ay™, the Apple™ App Store, the Microsoft™ store, or other app store. The personal mobile devices 90, 94 can then each install the application 92, 96. The application 92, 96 can then be launched by the user, and can include a graphical user interface (GUI) at least in some embodiments. The user can then use the GUI to initiate a process to establish a vehicle trip, which can include specifying certain vehicles as a follower vehicle or a leader vehicle, as well inputting other vehicle trip parameters (e.g., start time).

In at least one embodiment, the first personal mobile device 90 can be associated with the leader vehicle 12. For example, a user (e.g., lessee, owner) can provide certain user information (e.g., username, password, other credentials) to the vehicle user application 92, which can then determine one or more associated vehicles for that user based on information stored at the backend facility 80. The first personal mobile device 90 can then be used to carry out vehicle-related functionality for the associated vehicle, which is leader vehicle 12 in this example. When the first personal mobile device 90 is associated with the leader vehicle 12, the first personal mobile device 90 can be referred to as a leader vehicle device, which is any electronic device that is associated with a leader vehicle and that is carried by a person in the leader vehicle during a vehicle trip in which the vehicle is a leader vehicle. Also, in at least one embodiment, the second personal mobile device 94 can be associated with the follower vehicle 14. When the second personal mobile device 94 is associated with the follower vehicle 14, the second personal mobile device 94 can be referred to as a follower vehicle device, which is any electronic device that is associated with a follower vehicle and that is carried by a person in the follower vehicle during a vehicle trip in which the vehicle is a follower vehicle.

In some embodiments, the personal mobile devices 90, 94 can also be used to send commands to the vehicle, such as to remotely start the vehicle's engine (or other primary propulsion system), to lock/unlock vehicle doors, etc. Also, in some embodiments, the personal mobile devices 90, 94 can also enable the user to view status information concerning the vehicle, such as the status of one or more roadways, and/or the status of other vehicles participating in a vehicle trip, such as the location of the leader vehicle 12, the follower vehicle 14, and/or other follower vehicles (in embodiments where there may be multiple follower vehicles). In some embodiments, the vehicle user applications 92, 96 can be used to provide information to the backend facility 80, which can include vehicle trip information including leader vehicle identification information, follower vehicle identification information, other trip parameters, etc.

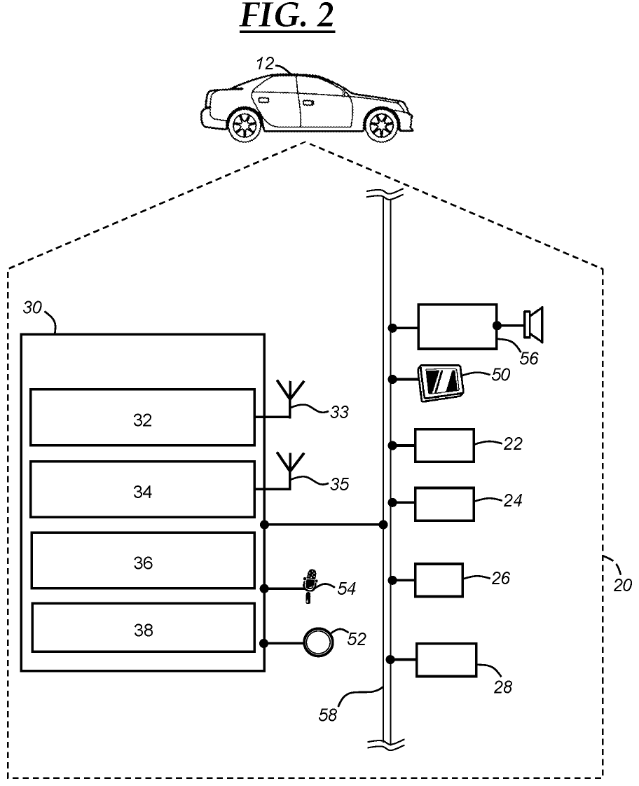

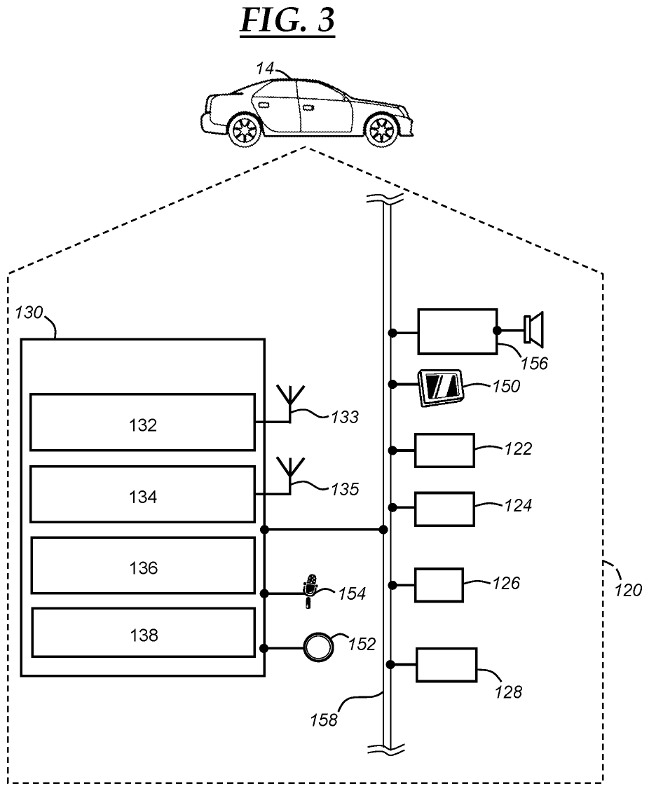

The leader vehicle 12 and the follower vehicle 14 are both vehicles that are participating in the same vehicle trip, and thus both the leader vehicle 12 and the follower vehicle 14 are considered participating vehicles for the vehicle trip. The leader vehicle 12 is the leader of the vehicle trip and is followed by the follower vehicle 14. In some embodiments, there may be multiple follower vehicles even though the illustrated embodiment only depicts a single follower vehicle. Also, although only the vehicle electronics 20 of the leader vehicle 12 (FIG. 2) are specifically described below, the below discussion of the vehicle electronics 20 of the leader vehicle 12 also refers to those like components of the vehicle electronics 120 of the follower vehicle 14, which is illustrated in FIG. 3.

The leader vehicle 12 and the follower vehicle 14 are both depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 of the leader vehicle 12 are shown generally in FIG. 2 and include a global navigation satellite system (GNSS) receiver 22, body control module or unit (BCM) 24, engine control module (ECM) 26, other vehicle system modules (VSMs) 28, a wireless communications device 30, and vehicle-user interfaces 50-56. Some or all of the different vehicle electronics 20 may be connected for communication with each other via one or more communication busses, such as bus 58. The communications bus 58 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few. In other embodiments, any one or more of the VSMs can communicate using a wireless network and can include suitable hardware, such as short-range wireless communications (SRWC) circuitry. Of course, any suitable combination of these communication techniques can be used as well.

The leader vehicle 12 can include numerous vehicle system modules (VSMs) as part of vehicle electronics 20, such as the GNSS receiver 22, BCM 24, ECM 26, wireless communications device 30, and vehicle-user interfaces 50-56, as will be described in detail below. The leader vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is connected by communications bus 58 to the other VSMs, as well as to the wireless communications device 30. One or more VSMs 28 may periodically or occasionally have their software or firmware updated and, in some embodiments, such vehicle updates may be over the air (OTA) updates that are received from the remote computer(s) 78 or backend facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives GNSS signals from a constellation of GNSS satellites. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 68. And, in another example, GNSS receiver 22 can be a BDS receiver that receives a plurality of GNSS (or BDS) signals from a constellation of GNSS (or BDS) satellites 68. In either implementation, GNSS receiver 22 can include at least one processor and memory, including a non-transitory computer readable memory storing instructions (software) that are accessible by the processor for carrying out the processing performed by the GNSS receiver 22.

The GNSS receiver 22 may be used to provide navigation and other position-related services to the vehicle operator. Navigation information can be presented on the display 50 (or other display within the vehicle such as an application program on mobile device 90) or can be presented verbally such as is done when supplying turn-by-turn navigation. The navigation services can be provided using a dedicated in-vehicle navigation module (which can be part of GNSS receiver 22 and/or incorporated as a part of wireless communications device 30 or other VSM), or some or all navigation services can be done via the vehicle communications device (or other telematics-enabled device) installed in the vehicle, wherein the position or location information is sent to a remote location for purposes of providing the vehicle with navigation maps, map annotations (points of interest, restaurants, etc.), route calculations, and the like. The position information can be supplied to the vehicle backend services facility 80 or other remote computer system, such as the remote computer(s) 78, for other purposes, such as fleet management. Also, new or updated map data, such as that geographical roadway map data stored on databases 84, can be downloaded to the GNSS receiver 22 from the backend facility 80 via vehicle communications device 30, as well as planned route information.

The GNSS receiver 22 can periodically determine the location of the leader vehicle 12 through receiving a plurality of GNSS signals from the GNSS satellites 68. This location (an example of a leader vehicle location) can be stored in memory, such as the memory 38 of the wireless communications device 30, or other memory of the vehicle. The leader vehicle location can also be sent to the first personal mobile device 90, the backend facility 80 and/or the remote computer(s) 78, which may provide the leader vehicle location to a follower vehicle device, such as the follower vehicle 14 or the second personal mobile device 94. In other embodiments, the leader vehicle location can be provided to a follower vehicle device directly, such as through a connection between the first personal mobile device 90 and the second personal mobile device 94, which (in some embodiments) can be facilitated or carried out using the vehicle user applications 92, 96. In other embodiments, the leader vehicle location can be determined by using a GNSS receiver included as a part of another leader vehicle device. For example, the first personal mobile device 90 can include a GNSS receiver and can periodically record the GNSS location, which can be used as the leader vehicle location. This leader vehicle location can then be provided to the leader vehicle 12, the follower vehicle 14, and/or the second personal mobile device 94.

The body control module (BCM) 24 can be used to control various VSMs of the vehicle, as well as obtain information concerning the VSMs, including their present state or status, as well as sensor information. The BCM 24 is shown in the exemplary embodiment of FIG. 2 as being electrically coupled to communication bus 58. In some embodiments, the BCM 24 may be integrated with or part of a center stack module (CSM) and/or integrated with wireless communications device 30. Or, the BCM 24 may be a separate device that is connected to other VSMs via bus 58. The BCM 24 can include a processor and/or memory, which can be similar to processor 36 and memory 38 of wireless communications device 30, as discussed below. The BCM 24 may communicate with wireless device 30 and/or one or more vehicle system modules, such as the GNSS receiver 22, the ECM 26, the audio system 56, or other VSMs 28. The BCM 24 may include a processor and memory accessible by the processor. Suitable memory may include non-transitory computer-readable memory that includes various forms of non-volatile RAM and ROM, including any of those exemplary memory types discussed with respect to memory 38 of the wireless communications device 30. Software stored in the memory and executable by the processor enables the BCM to direct one or more vehicle functions or operations including, for example, controlling central locking, air conditioning (or other HVAC functions), power mirrors, controlling the vehicle primary mover (e.g., engine, primary propulsion system), and/or controlling various other vehicle modules. For example, the BCM 24 can send signals to other VSMs, such as a request to perform a particular operation or a request for sensor information and, in response, the sensor may then send back the requested information.

Additionally, in some embodiments, the BCM 24 may provide vehicle state information corresponding to the vehicle state or of certain vehicle components or systems, including the VSMs discussed herein. For example, the BCM 24 may provide the wireless communications device 30 with information indicating whether the vehicle's primary propulsion system is engaged or in an active (or ready) state (or when the ignition is turned on as received from an engine control module in an ICE vehicle) and/or other information regarding the vehicle. The information can be sent to the wireless communications device 30 (or other central vehicle computer) automatically upon receiving a request from the device/computer, automatically upon certain conditions being met, or periodically (e.g., at set time intervals or to indicate the conclusion of a trip).

As mentioned above, in the illustrated embodiment, the vehicle 12 includes an internal combustion engine (ICE) and is referred to as an ICE vehicle. ICE vehicles may solely use an ICE for propulsion or may use a combination of another energy generator or store (such as a battery) and the ICE. In the case of an ICE vehicle, the vehicle can include an engine control module (ECM) 26 that controls various aspects of engine operation such as fuel ignition and ignition timing. The ECM 26 can be connected to communications bus 58 and may receive operation instructions from BCM 24 or other vehicle system modules, such as wireless communications device 30 or VSMs 28. The ECM 26 can also be used to obtain sensor information of the vehicle engine.

The engine control module (ECM) 26 may control various aspects of engine operation such as fuel ignition and ignition timing. The ECM 26 is connected to the communications bus 58 and may receive operation instructions (or vehicle commands) from the BCM 24 or other vehicle system modules. In one scenario, the ECM 26 may receive a command from the BCM 24 (or other VSM) to place the vehicle in a primary propulsion on state (from a primary propulsion off state)—i.e., initiate the vehicle ignition or other primary propulsion system (e.g., a battery powered motor). In at least some embodiments when the vehicle is a hybrid or electric vehicle, a primary propulsion control module can be used instead of (or in addition to) the ECM 26, and this primary propulsion control module can be used to obtain status information regarding the primary mover (including electrical motor(s) and battery information). A primary propulsion off state refers to a state in which the primary propulsion system of the vehicle is off, such as when the internal combustion engine is not running or idling, when a vehicle key is not turned to a START or ON (or accessory) position, or when the power control system for one or more electric motors of an electric vehicle is powered off or not enabled. A primary propulsion on state is a state that is not a primary propulsion off state.

The vehicle 12 includes various onboard vehicle sensors. Also, certain vehicle-user interfaces 50-54 can be utilized as onboard vehicle sensors. Generally, the sensors can obtain information pertaining to either the operating state of the vehicle (the “vehicle operating state”) or the environment of the vehicle (the “vehicle environmental state”). The sensor information can be sent to other VSMs, such as BCM 24 and the vehicle communications device 30, via communications bus 58. Also, in some embodiments, the sensor data can be sent with metadata, which can include data identifying the sensor (or type of sensor) that captured the sensor data, a timestamp (or other time indicator), and/or other data that pertains to the sensor data, but that does not make up the sensor data itself. The “vehicle operating state” refers to a state of the vehicle concerning the operation of the vehicle, which can include the operation of the primary mover (e.g., a vehicle engine, vehicle propulsion motors). Additionally, the vehicle operating state can include information concerning mechanical operations of the vehicle or electrical states of the vehicle. The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle.

Additionally, the vehicle 12 can include other sensors not mentioned above, including cameras, parking sensors, wheel speed sensors, inertial sensors (e.g., accelerometers, gyroscopes), lane change and/or blind spot sensors, lane assist sensors, ranging sensors (i.e., sensors used to detect the range between the vehicle and another object, such as through use of radar or lidar), other radars, other lidars, tire-pressure sensors, fluid level sensors (including a fuel level sensor), brake pad wear sensors, V2V communication unit (which may be integrated into the wireless communications device 30), rain or precipitation sensors (e.g., infrared light sensor(s) directed toward the windshield (or other window of the vehicle 12) to detect rain or other precipitation based on the amount of reflected light), and interior or exterior temperature sensors.

Wireless communications device 30 is capable of communicating data via short-range wireless communications (SRWC) and/or via cellular network communications through use of a cellular chipset 34, as depicted in the illustrated embodiment. In one embodiment, the wireless communications device 30 is a central vehicle computer that is used to carry out at least part of the method discussed below. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), body control module (BCM) 24, an infotainment module, a head unit, and/or a gateway module. In some embodiments, the device 30 can be implemented as an OEM-installed (embedded) or aftermarket device that is installed in the vehicle. In one embodiment, the wireless communications device 30 can include a telematics unit (or telematics control unit) that is capable of carrying out cellular communications using one or more wireless carrier systems 70. In other embodiments, the telematics or cellular functionality of the wireless communications device 30 can be integrated into a separate telematics unit, and the SRWC functionality can be implemented as a part of an infotainment unit or other VSM of the vehicle electronics 20. In one embodiment, the telematics unit can be integrated with the GNSS receiver 22 so that, for example, the GNSS receiver 22 and the wireless communications device (or telematics unit) 30 are directly connected to one another as opposed to being connected via communications bus 58.

In some embodiments, the wireless communications device 30 can be configured to communicate wirelessly according to one or more short-range wireless communications (SRWC) such as any of the Wi-Fi™, WiMAX™, Wi-Fi Direct™, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device, such as the first personal mobile device 90, the second personal mobile device 94, and/or the follower vehicle 14. In at least some embodiments, the wireless communications device 30 can be used to carry out vehicle-to-vehicle (V2V) communications with the follower vehicle 14. Additionally, in some embodiments, the wireless communications device may contain a cellular chipset 34 thereby allowing the device to communicate via one or more cellular protocols, such as those used by cellular carrier system 70. In such a case, the wireless communications device becomes user equipment (UE) usable in carrying out cellular communications via cellular carrier system 70.

The wireless communications device 30 may enable the vehicle 12 to be in communication with one or more remote networks (e.g., one or more networks at backend facility 80 or computers 78) via packet-switched data communication. This packet-switched data communication may be carried out through use of a non-vehicle wireless access point that is connected to a land network via a router or modem. When used for packet-switched data communication such as TCP/IP, the wireless communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, in some embodiments, the processor 36 can execute programs or process data to carry out at least a part of the method discussed herein. The memory 38 may be a temporary powered memory, any non-transitory computer-readable medium, or other type of memory. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and/or magnetic or optical disc drives. Similar components to those previously described (processor 36 and/or memory 38, as well as SRWC circuit 32 and cellular chipset 34) can be included in body control module 24, the ECM 26, the GNSS receiver 22, and/or various other VSMs that typically include such processing/storing capabilities.

In one embodiment, the wireless communications device 30 can be incorporated with or at least connected to a navigation system that includes geographical map information including geographical roadway map data. The navigation system can be communicatively coupled to the GNSS receiver 22 (either directly or via communications bus 58) and can include an on-board geographical map database that stores local geographical map information. This local geographical map information can be provisioned in the vehicle and/or downloaded via a remote connection to a geographical map database/server, such as the remote computer 78 and/or backend facility 80 (including servers 82 and databases 84). The on-board geographical map database can store geographical map information corresponding to a location or region of the vehicle so as to not include a large amount of data, much of which may never be used. Moreover, as the vehicle 12 enters different locations or regions, the vehicle can inform the vehicle backend services facility 80 of the vehicle's location (e.g., obtained via use of GNSS receiver 22) and, in response to receiving the vehicle's new location, the servers 82 can query databases 84 for the corresponding geographical map information, which can then be sent to the vehicle 12.

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, or control input. Audio system 56 provides audio output to a vehicle occupant and can be a dedicated, stand-alone system or part of the primary vehicle audio system. According to the particular embodiment shown here, audio system 56 is operatively coupled to both vehicle bus 58 and an entertainment bus (not shown) and can provide AM, FM and satellite radio, CD, DVD and other multimedia functionality. This functionality can be provided in conjunction with or independent of an infotainment module. Microphone 54 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, or a projector that can project graphics for viewing by a vehicle occupant. Various other human-machine interfaces (HMIs) can also be utilized, such as a display of the first personal mobile device 90, as the interfaces of FIG. 2 are only an example of one particular implementation.

A user of the leader vehicle 12 can use one or more HMIs, as discussed more below, to input vehicle trip parameters, such as a start location, an end location, leader vehicle identification information, follower vehicle identification information, other information concerning the leader vehicle 12 or other participating vehicles, and/or a time of departure. In one embodiment, the user can operate one or more vehicle-user interfaces 50-56, which can then deliver inputted information to other VSMs, such as the wireless communications device 30. The wireless communications device 30 can then send this information to the first personal mobile device 90, the remote computer 78, and/or to the backend facility 80 using the cellular chipset 34 or other communications means. For example, the user can use the touchscreen display 50 to indicate that the vehicle is being used as a leader vehicle for a vehicle trip.

In some embodiments, the user may not specify a particular end location or destination of the vehicle trip. And, in other embodiments, the user can input an end location or a destination (referred to collectively herein as “destination”), which can include a physical address (e.g., 1234 Main Street, Central City, Mich.) or can include a point of interest or other geographical indicator. The destination can be represented in many forms, such as through geographical coordinates or textual data. The vehicle start location can be specified by the user via the vehicle-user interfaces or the HMIs of the first personal mobile device 90, may be determined based on a schedule of the user, or may be determined or preset to be the vehicle's current location, which can be determined using GNSS receiver 22 or through use of other location services, such as through a GNSS receiver of the first personal mobile device 90. This information can be sent using the wireless communications device 30 (e.g., through SRWC circuitry 32 or cellular chipset 34) to the backend facility 80 or other remote computing system (e.g., computer 78), which can provide navigational information to the vehicle 12. This navigational information can be displayed on the display 50, or may be presented via use of other vehicle-user interfaces that can be used for presenting output. The navigational information can provide one or more route segments as well as geographical roadway map data.

With reference to FIG. 3, there is shown a block diagram depicting vehicle electronics 120 of the follower vehicle 14. The follower vehicle 14 includes a GNSS receiver 122, a BCM 124, an ECM 126, other VSMs 128, a wireless communications device 130 (including a SRWC circuit 132, cellular chipset 134, processor 136, memory 138, and antennas 133, 135), and vehicle-user interfaces 150-156. The components 122-156 are the same or similar to those of the vehicle electronics 20 of the leader vehicle 12 as discussed above, and that discussion is incorporated herein and not repeated for purposes of brevity. Also, although the leader vehicle 12 and the follower vehicle 14 include the same or similar vehicle electronics, it should be appreciated that these vehicles 12, 14 do not have to include the same components and these vehicle 12, 14 may be different models, makes, etc. In the illustrated embodiment, the vehicle electronics 120 of the follower vehicle 14 are considered a follower vehicle device.

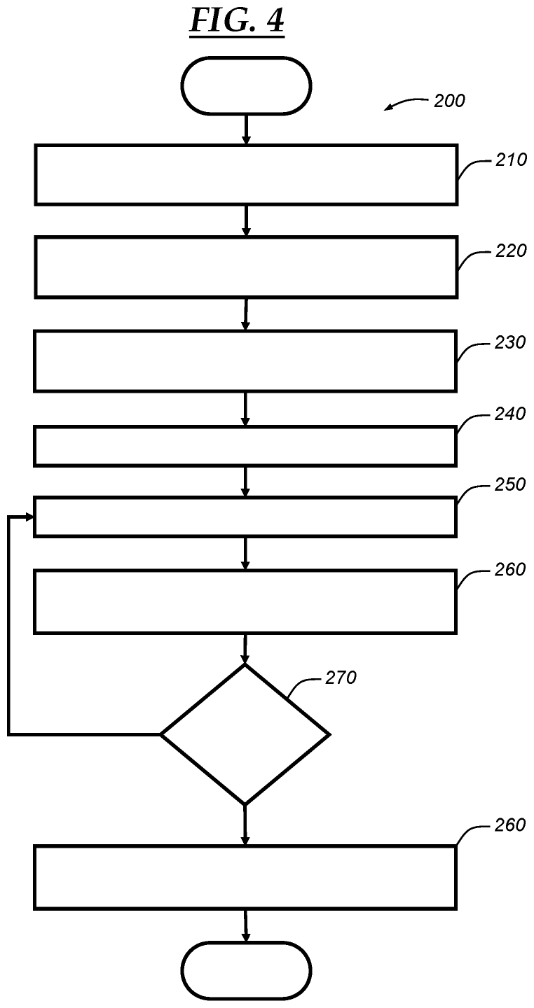

With reference to FIG. 4, there is shown an embodiment of a method 200 of providing dynamic vehicle navigation information to a follower vehicle based on a leader vehicle location of a leader vehicle. In one embodiment, one or more steps of the method 200 can be carried out by the backend facility 80 using one or more servers 82 and, in at least some embodiments, can be carried out using a plurality of servers. In another embodiment, one or more steps of the method 200 can be carried out at the leader vehicle 12, the follower vehicle 14, and/or both. In other embodiments, one or more steps of the method 200 can be carried out by the remote computer(s) 78, or may be carried out by a combination of the servers 82 of the backend facility 80 and the remote computer(s) 78. The steps of the method 200 can be carried out according to any technically feasible order, as appreciated by those skilled in the art.

The method 200 begins with step 210, wherein a communication link is established between a leader vehicle device and a follower vehicle device. As mentioned above, the leader vehicle device can be a VSM or other portion of the vehicle electronics, such as the wireless communications device 30 of the leader vehicle 12, or may be a personal mobile device such as the first personal mobile device 90. Likewise, the follower vehicle device can be a VSM or other portion of the vehicle electronics, such as the wireless communications device 130 of the follower vehicle 14, or may be a personal mobile device such as the second personal mobile device 94. In in at least some embodiments, this communication link can be used for various communications that are carried out between the leader vehicle device(s) and the follower vehicle device(s) as a part of the method 200. In one embodiment, the communication link is a short-range wireless communication (SRWC) link between the leader vehicle device and the follower vehicle device.

For example, a SRWC link, such as Bluetooth™ (e.g., BLE), can be established between the leader vehicle device and the follower vehicle device. In one embodiment, the vehicle user application 92 of the first personal mobile device 90 and/or the vehicle user application 96 of the second personal mobile device 94 can be used to initiate and/or facilitate the establishment of this SRWC link, such as through searching for other devices that may be using the vehicle user application and/or looking to participate in a vehicle trip. For example, in one embodiment, a first user of the first personal mobile device 90 can launch the vehicle user application 92, and a second user of the second personal mobile device 94 can launch the vehicle user application 96. One or both of the vehicle user application 92 and the vehicle user application 96 can then search for other devices that are seeking to participate in a vehicle trip (or that are associated with a vehicle seeking to participate in a vehicle trip), and the other of the vehicle user application 92 and the vehicle user application 96 can respond to this inquiry, such as through sending a response message. These messages can be sent via Bluetooth™, for example. This searching can include broadcasting a particular message using a SRWC circuit, and the broadcasted message can include a name of the broadcasting device, associated vehicle, and/or associated user(s). Devices that are within range (and suitably configured, such as through the installation of the vehicle user application 92, 96) can receive this broadcasted message and display information contained therein. In some embodiments, multiple broadcasted messages can be received from multiple devices, and the corresponding information (including a vehicle trip identifier) displayed. This displayed information can include a vehicle trip name or identifier, a vehicle name or identifier of other participating vehicles, a name of a user, or other indicator that identifies an individual or a vehicle that is to participate in the vehicle trip—any of this information (including any combination of this information) can be used as the vehicle trip identifier. The user can then select one (or more in some embodiments) of the displayed vehicle trip identifier(s) using an HMI of their device and then this selected vehicle trip identifier can be used to identify the other device that is to be communicatively linked to their device, and this can include identifying the device to which to send the response message.

In another embodiment, after launching or loading the vehicle user application 92 and the vehicle user application 96 (at the respective devices 90, 94), the first and/or second user can place the first personal mobile device 90 within NFC operating range (i.e., a range in which communications can be communicated from the first device to the second device via NFC) of the second personal mobile device 94 (or vice versa), and these devices (e.g., through apps 92, 96) can determine that the vehicles 12 and 14 are to participate in a vehicle trip and can thus be communicatively linked to one another for purposes of the vehicle trip. In another embodiment, the vehicles 12 and 14 can be communicatively linked by the first personal mobile device 90 using a camera to scan a QR code of the vehicle 14 (or the second personal mobile device 94). Also, in other embodiments, the vehicles 12 and 14 can be communicatively linked by the second personal mobile device 94 using a camera to scan a QR code of the vehicle 12 (or the first personal mobile device 90). The leader vehicle identification information and/or the follower vehicle identification information can be communicated between the first personal mobile device 90 and the second personal mobile device 94 via these communications (e.g., Bluetooth™, NFC).

In another embodiment, a remote link can be established between the leader vehicle device and the follower vehicle device. The remote link can be a cellular link or other long range wireless communication link, and/or may include a link that is established through a remote computer, such as servers 82 and/or the remote computer(s) 78. In one embodiment, the leader vehicle device and the follower vehicle device can send their location (e.g., a GNSS location) to the remote computer, and then the remote computer can determine that the leader vehicle device and the follower vehicle device are to be communicatively linked since their locations are within a predetermined distance from one another. Or, instead of automatically establishing the remote link based on the location, the remote computer can prompt one or both of the devices to confirm that the other device is the device intended to establish the remote link with or that the other device is participating (or is to be participating) in the same vehicle trip. The method 200 continues to step 220.

In step 220, leader vehicle identification information is obtained. The leader vehicle identification information is information or data identifying or indicating that a particular vehicle is to be a leader vehicle in a vehicle trip. The leader vehicle identification information can include a vehicle identification number (VIN) or other vehicle identifier, as well as an associated indicator that indicates the vehicle identified by the vehicle identifier is to be a leader vehicle in the vehicle trip. In one embodiment, the leader vehicle identification information includes an indicator that indicates an associated vehicle is to be a leader vehicle in the vehicle trip. At least in this example, the associated vehicle is the vehicle that is associated with the leader vehicle device that obtains or provides the leader vehicle identification information. For example, the first personal mobile device 90 may be associated with the vehicle 12 such that the first personal mobile device 90 is considered a leader vehicle device. This leader vehicle device 90 can then receive an indication from a user via HMIs of the device 90 that indicates the associated vehicle (i.e., vehicle 12 in this example) is to be a leader vehicle in the vehicle trip.

The leader vehicle identification information can be obtained at a leader vehicle device, which can be the wireless communications device 30 of the leader vehicle 12 or the first personal mobile device 90. In one embodiment, the leader vehicle identification information can be received via an HMI of the first personal mobile device 90, such as through a touchscreen display of the first personal mobile device 90. The vehicle user application 92 can be used to provide the GUI and/or to otherwise receive the leader vehicle identification information. In another embodiment, the vehicle-user interfaces 50-54 can be used to receive or otherwise obtain the leader vehicle identification information. Once the leader vehicle device obtains the leader vehicle identification information, the leader vehicle identification information can be sent to the backend facility 80 and stored in databases 84, or may be sent to the remote computers 78 and stored thereat. Additionally or alternatively, the leader vehicle identification information can be sent to the follower vehicle device, such as the second personal mobile device 94 or the wireless communications device 130 of the follower vehicle 14. The method 200 continues to step 230.

In step 230, follower vehicle identification information is obtained. The follower vehicle identification information is information or data identifying or indicating that a particular vehicle is to be a follower vehicle in a vehicle trip. The follower vehicle identification information can include a vehicle identification number (VIN) or other vehicle identifier, as well as an associated indicator that indicates the vehicle identified by the vehicle identifier is to be a follower vehicle in the vehicle trip. In one embodiment, the follower vehicle identification information includes an indicator that indicates an associated vehicle is to be a follower vehicle in the vehicle trip. The associated vehicle is the vehicle that is associated with the follower vehicle device that obtains or provides the follower vehicle identification information. For example, the second personal mobile device 94 may be associated with the vehicle 14 such that the second personal mobile device 94 is considered a follower vehicle device. This follower vehicle device 90 can then receive an indication from a user via HMIs of the device 90 that indicates the associated vehicle (i.e., vehicle 14 in this example) is to be a follower vehicle in the vehicle trip.

The follower vehicle identification information can be obtained at a vehicle follower device, which can be the vehicle electronics 120 of the follower vehicle 14 or the second personal mobile device 94. In one embodiment, the follower vehicle identification information can be received via an HMI of the second personal mobile device 94, such as through a touchscreen display of the second personal mobile device 94. The vehicle user application 96 can be used to provide the GUI and/or to otherwise receive the follower vehicle identification information. In another embodiment, the vehicle-user interfaces 50-54 can be used to receive or otherwise obtain the follower vehicle identification information. Once the follower vehicle device obtains the follower vehicle identification information, the follower vehicle identification information can be sent to the backend facility 80 and stored in databases 84, or may be sent to the remote computers 78 and stored thereat. Additionally or alternatively, the follower vehicle identification information can be sent to the leader vehicle device, such as the first personal mobile device 90 or the vehicle electronics 20 of the leader vehicle 12.

In some embodiments, a single device (e.g., the first personal mobile device 90, the second personal mobile device 94, a VSM of the leader vehicle 12, a VSM of the follower vehicle 14) can receive both the follower vehicle identification information and the leader vehicle identification information from a user. For example, in a case in which the follower vehicle identification information and the leader vehicle identification information is received at the first personal mobile device 90, the first personal mobile device 90 can then send this information to the backend facility 80, which can then identify a follower vehicle device based on the follower vehicle identification information. The backend facility 80 may then send a message to the follower vehicle device indicating that the vehicle 14 has been identified as a follower vehicle in a vehicle trip. This message (or other messages) can be sent to the follower vehicle device indicating other participating vehicles, such as the leader vehicle 12. In another example in which the follower vehicle identification information and the leader vehicle identification information is received at the second personal mobile device 94, the second personal mobile device 94 can then send this information to the backend facility 80, which can then identify a leader vehicle device based on the leader vehicle identification information. The backend facility 80 may then send a message to the leader vehicle device indicating that the vehicle 12 has been identified as a leader vehicle in a vehicle trip. This message (or other messages) can be sent to the leader vehicle device identifying other participating vehicles, such as the follower vehicle 14. Also, in some embodiments where a vehicle is identified by another device (or non-associated device) as being a participating vehicle in the vehicle trip, the user can be prompted to confirm that the vehicle will be or is a participating vehicle in the vehicle trip and/or to confirm that the vehicle is either a leader vehicle or a follower vehicle. This confirmation can be sent to the backend facility 80 (or other remote server). In one embodiment, the leader vehicle device can be used to confirm the identity of the follower vehicle(s) and/or to indicate whether the user of the leader vehicle wants the follower vehicle(s) to receive the leader vehicle location.

In one embodiment, and as discussed above with respect to step 210, the leader vehicle device and the follower vehicle device can be associated with each other through a remote link and/or a SRWC link, which can include wireless communications according to Bluetooth™ connection. This link can be used to share the leader vehicle identification information with the follower vehicle device, and/or to share the follower vehicle identification information with the leader vehicle device. In response to receiving or otherwise obtaining the participating vehicle identification information (i.e., the leader vehicle identification information and the follower vehicle identification information), one or more of the leader vehicle devices and/or the follower vehicle devices can additionally send the leader vehicle identification information and/or the follower vehicle identification information to the backend facility 80, the remote computer(s) 78, and/or other device(s).

In some embodiments, a vehicle trip identifier or other vehicle trip information can be generated or obtained in response to receiving leader vehicle identification information, follower vehicle identification information, or another indication that a vehicle trip is being configured. For example, a user can provide leader vehicle identification information into the first personal mobile device 90 via HMIs of the first personal mobile device 90, and then the app 92 can send this information to the backend facility 80. The backend facility 80 then can provide vehicle trip information (e.g., the leader vehicle identification information, other identification information of the leader vehicle or other participating vehicles, a vehicle trip identifier, a vehicle trip name) to one or more vehicles (e.g., vehicle 14) or personal mobile devices (e.g., device 94) that are located near the leader vehicle and/or that previously participated in a vehicle trip with the leader vehicle. A user of the second personal mobile device 94 (or other device to which the vehicle trip information was sent) can then confirm that the vehicle 14 is participating as a follower vehicle in the vehicle trip. Also, in some embodiments, the user may edit the vehicle trip information, and then these updates can be provided to the backend facility 80, the first personal mobile device 90, the leader vehicle 12 (or other participating vehicle device(s)).

As another example, a user can input follower vehicle identification information into the second personal mobile device 94 via HMIs of the second personal mobile device 94, and then the vehicle user application 96 can send this information to the backend facility 80. The backend facility 80 then can provide vehicle trip information (e.g., the follower vehicle identification information, other identification information of the follower vehicle or other participating vehicles, a vehicle trip identifier, a vehicle trip name) to one or more vehicles (e.g., vehicle 12) or personal mobile devices (e.g., device 92) that are located near the follower vehicle and/or that previously participated in a vehicle trip with the follower vehicle. A user of the first personal mobile device 92 (or other device to which the vehicle trip information was sent) can then confirm that the vehicle 12 is participating as a leader vehicle in the vehicle trip. Also, in some embodiments, the user may edit the vehicle trip information, and then these updates can be provided to the backend facility 80, the second personal mobile device 94, the follower vehicle 14 (or other participating vehicle device(s)). The method 200 continues to step 240.

In step 240, it is determined that the vehicle trip is starting. In in at least some embodiments, this determination can be made by receiving an indication that the vehicle trip is starting (also referred to as a “vehicle trip start indication”). The vehicle trip start indication can be an indication received from a leader vehicle device, such as through a user of the leader vehicle device selecting a “START TRIP” option. In another embodiment, this vehicle trip start indication can be generated or received automatically, such as by the leader vehicle device determining that the leader vehicle 12 is moving, or is departing the vehicle trip start location (which can be specified as a part of the configuration process). In another embodiment, the vehicle trip start indication can be received from another device, such as a follower vehicle device, the backend facility 80, or the remote computer(s) 78. The method 200 then continues to step 250.

In step 250, a leader vehicle location of the leader vehicle is obtained. This location information is obtained periodically, which can be at regular or irregular intervals. The leader vehicle location is a location of the leader vehicle, and can be obtained at a leader vehicle device by a GNSS receiver of the leader vehicle device, such as at the leader vehicle 12 by the GNSS receiver 22, or at the first personal mobile device 90 by a GNSS receiver of the device 90. The leader vehicle location can be stored into memory at the leader vehicle device, and/or sent to another device, such as another leader vehicle device (e.g., the wireless communications device 30 can send the leader vehicle location to the first personal mobile device 90), the backend facility 80, and/or the remote computer(s) 78. In in at least one embodiment, the leader vehicle location is a geographical coordinate location that is obtained using a GNSS receiver (referred to as a GNSS location). This GNSS location can be accompanied by a timestamp (or other time indicator), which can be determined by the GNSS receiver based on GNSS signals received from satellites 68. The leader vehicle location can also be sent from the leader vehicle device to a follower vehicle device, such as to the vehicle electronics of the follower vehicle 14. In one embodiment, the leader vehicle location is sent directly from the leader vehicle device to the wireless communications device 130 of the follower vehicle 14. The leader vehicle location can be sent to the follower vehicle (or other follower vehicle device) directly via direct connection between the follower vehicle and the leader vehicle device. The direct connection can be established using the wireless carrier system and/or land network 76, but not via the backend facility 80 and/or remote computer(s) 78. In some embodiments, the follower vehicle can use this leader vehicle location to obtain the dynamic vehicle navigation information. The method 200 continues to step 260.

In step 260, dynamic vehicle navigation information is sent to a follower vehicle device. The dynamic vehicle navigation information includes navigation information that is based on the leader vehicle location. The navigation information can include directions (e.g., a leader vehicle location or waypoint derived therefrom) and/or can include navigation instructions (e.g., route instructions or information that leads the vehicle along a particular route). In some embodiments, the remote computer that obtained the leader vehicle location in step 250 can determine dynamic vehicle navigation information based on the leader vehicle location, and then can send this dynamic vehicle navigation information to the follower vehicle device (or another follower vehicle device). In one embodiment, the remote computer is a first remote computer that sends the leader vehicle location (or information based thereon (e.g., a waypoint determined from the leader vehicle location)) to a follower vehicle device, which then sends this leader vehicle location or information to a second remote computer. The second remote computer can then determine dynamic vehicle navigation information and then send the dynamic vehicle navigation information to the follower vehicle device. In another embodiment, the first remote computer (i.e., in this embodiment, the remote computer that obtained the leader vehicle location in step 250) can send the leader vehicle location directly to a second remote computer, which can then determine dynamic vehicle navigation information and then send the dynamic vehicle navigation information back to the first remote computer or directly to the follower vehicle device. In the case that the second remote computer sends the dynamic vehicle navigation information to the first remote computer, the first remote computer can then send the dynamic vehicle navigation information to the follower vehicle device.

In at least some embodiments, the leader vehicle location is sent to the follower vehicle device via the communication link. In one embodiment, the leader vehicle location is sent from the backend facility 80 to the follower vehicle device via land network 76 and/or wireless carrier system 70. In another embodiment, the leader vehicle location is sent directly from the leader vehicle device to the follower vehicle device, such as through a cellular connection or other wireless connection. Once the follower vehicle device obtains the leader vehicle location, the follower vehicle device can display the leader vehicle location on a display of the follower vehicle device and/or can store the leader vehicle location in memory of the follower vehicle device. Also, the follower vehicle device can send the leader vehicle location to other follower vehicle devices. In some embodiments, the leader vehicle location is first sent to a remote computer (e.g., the backend facility 80 and/or remote computer(s) 78), and then sent to the follower vehicle device from the remote computer. In some embodiments, the remote computer can determine (or obtain) directions or other navigation information for directing the follower vehicle (or user thereof) to the leader vehicle. These directions (or other navigation information) can be periodically updated in response to periodically receiving the leader vehicle location from the leader vehicle device or remote computer/server.

In one embodiment, the leader vehicle location is displayed on the display 150 of the vehicle electronics 120 of the follower vehicle 14, or on a display of the second personal mobile device 94. The display can also include a geographical map that includes roadways of the surrounding area, and a leader vehicle location indicator can be displayed on this map at a location corresponding to the leader vehicle location. Also, at least in some embodiments, a follower vehicle location indicator can also be displayed on this map, and directions or a route between the leader vehicle location and the follower vehicle location can be indicated on the display, such as by displaying highlighted line(s) over the geographical map at locations corresponding to roads that connect the follower vehicle location to the leader vehicle location. The directions do not necessarily have to include a specific route, but at least include a leader vehicle location or waypoint based on the leader vehicle location so that the user and/or follower vehicle is directed to at least partially follow the leader vehicle location or the waypoint. The term “at least partially follow” when used in connection with the follower vehicle and the leader vehicle refers to the follower vehicle travelling over at least some of the same roads as the leader vehicle. In one embodiment, the follower vehicle can use the leader vehicle location (or a waypoint derived therefrom) to determine a route using an onboard navigation system, which can include using local geographical map information to determine a route between the follower vehicle and the provided location. The route includes a particular path between the follower vehicle location and the leader vehicle location (or waypoint). In some embodiments, the route can be provided from a remote computer and/or may be a part of the dynamic vehicle navigation information. Additionally or alternatively, directions (or other navigational information) can be presented to the user using other vehicle-user interfaces or HMIs, such as through using the audio system 56 to provide audible navigation instructions or other navigation information to the user of the follower vehicle 14. The method 200 then continues to step 270.

In step 270, a determination as to whether the vehicle trip is still ongoing is made. The determination of whether the vehicle trip is still ongoing can be made by determining that the leader vehicle has transitioned or been placed into a primary propulsion off state, which can include determining that the ignition of the vehicle 12 has been turned off. In some embodiments where a destination can be specified, the determination of whether the vehicle trip is still ongoing can be made by determining that the leader vehicle location (and/or the follower vehicle location) is within a predetermined distance of (or is the same or corresponds to) the destination. It should be appreciated that, in some embodiments, the method may automatically proceed back to step 250 until it is detected or otherwise determined that the vehicle trip is not ongoing or is over. In another embodiment, the determination of whether the vehicle trip is still ongoing can be made as a result of receiving user input indicating a desire to end the vehicle trip or to stop following the leader vehicle. When it is determined that the vehicle trip is still ongoing, then the method 200 continues back to step 250. In step 270, when it is determined that the vehicle trip is over, then the method 200 continues to step 280.

In step 280, the communication link between the leader vehicle device and the follower vehicle device is terminated. The termination of the communication link can include removing information or data that is used during the session, deleting cryptographic information used to secure communications over the communication link, sending a disconnection request (or deregistering request) from a first one of the leader vehicle device and the follower vehicle device to the other one of the leader vehicle device and the follower vehicle device, and/or ignoring communications received over the communication link at one or both of the leader vehicle device and the follower vehicle device. The method 200 then ends.

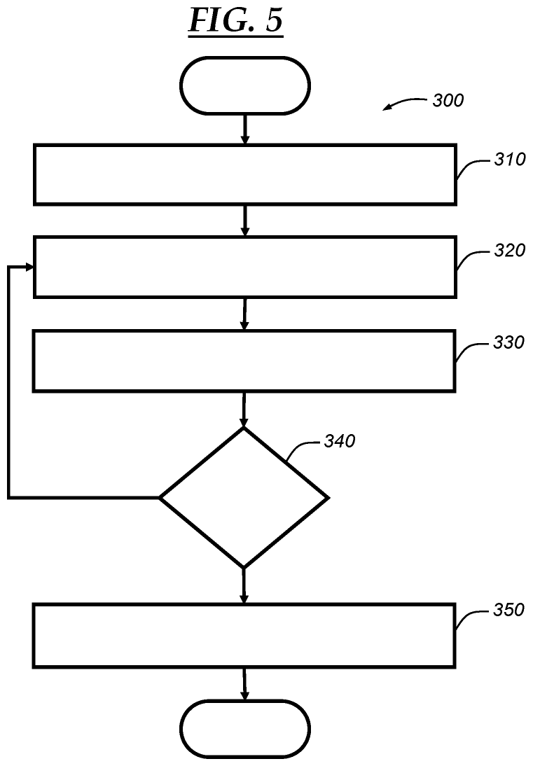

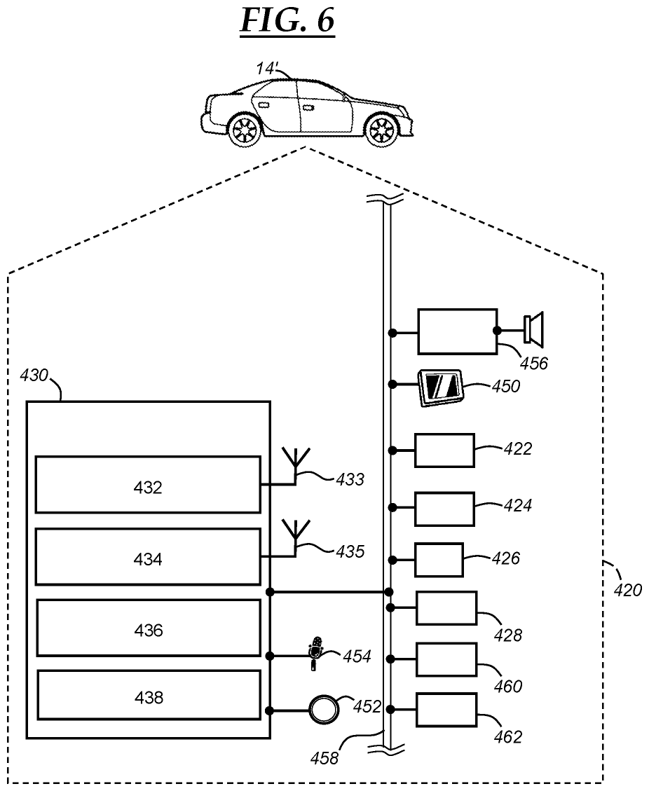

With reference to FIG. 5, there is shown another embodiment of a method 300 of providing dynamic vehicle navigation information to a follower vehicle based on a leader vehicle location of a leader vehicle. One or more steps of the method 300 can be carried out by the follower vehicle 14′ (FIG. 6). The steps of the method 300 can be carried out according to any technically feasible order, as appreciated by those skilled in the art. The method 300 pertains to embodiments in which the follower vehicle is an autonomous vehicle (AV), which is a vehicle that is a level two (2) or higher of the National Highway Traffic Safety Administration (NHSTA) AV levels.

With reference to FIG. 6, there is shown a block diagram depicting vehicle electronics 420 of the follower vehicle 14′. In some embodiments, the follower vehicle 14′ can be a level three (3) or higher of the NHSTA AV levels, or a level four (4) or higher of the NHSTA levels. With reference to FIG. 6, there is shown an autonomous follower vehicle 14′, which includes the same vehicle electronics 420 as those of the follower vehicle 14 (FIG. 3) as discussed above, but further includes an AV control unit 460, radars 462, and lidars 464. The follower vehicle 14′ includes a GNSS receiver 422, a BCM 424, an ECM 426, other VSMs 428, a wireless communications device 430 (including a SRWC circuit 432, cellular chipset 434, processor 436, memory 438, and antennas 433, 435), and vehicle-user interfaces 450-456. The components 422-456 are the same or similar to those of the vehicle electronics 20 of the leader vehicle 12 as discussed above, and that discussion is incorporated herein and not repeated for purposes of brevity.

The autonomous vehicle (AV) control unit 460 is a controller that helps manage or control autonomous vehicle operations, and that can be used to perform AV logic (which can be embodied in computer instructions) for carrying out the AV functionality. The AV control unit 460 includes a processor and memory, which can include any of those types of processor or memory discussed above with respect to the processor 36 and memory 38 of the wireless communications device 30. The AV control unit 460 can be a separate and/or dedicated module that performs AV operations, or may be integrated with one or more other electronic vehicle devices of the vehicle electronics 420. The AV control unit 460 is connected to the communications bus 458 and can receive information from one or more onboard vehicle sensors or other electronic vehicle devices, such as the BCM 424 or the GNSS receiver 422.

Radar(s) 462 include one or more radars, each of which is an example of an AV sensor. The radar(s) 462 are each a radar that uses radio waves to obtain spatial or other physical information regarding one or more objects within the field of view of the radar 462. The radar 462 includes a transmitter that transmits electromagnetic radio waves via use of a transmitting antenna and can include various electronic circuitry that enables the generation and modulation of an electromagnetic carrier signal. In other embodiments, the radar 462 can transmit electromagnetic waves within another frequency domain, such as the microwave domain. The radar 462 includes a signal processor, which can at least partially (e.g., fully) be implemented using the processor discussed above, or which may at least partially (e.g., fully) be implemented with dedicated circuitry. The radar 462 can include a separate receiving antenna, or the radar 462 can include a single antenna for both reception and transmission of radio signals. And, in other embodiments, the radar 46 can include a plurality of transmitting antennas, a plurality of receiving antennas, or a combination thereof so as to implement multiple input multiple output (MIMO), single input multiple output (SIMO), or multiple input single output (MISO) techniques. Although a single radar 462 is shown, the vehicle 14′ can include one or more radars that can be mounted at the same or different locations of the vehicle 14′.

The lidar(s) 464 include one or more lidars, each of which is an example of an AV sensor. The lidar(s) 464 are each a lidar that uses non-visible light waves to obtain spatial or other physical information regarding one or more objects within the field of view of the lidar 464. In many embodiments, the lidar 464 emits a plurality of light pulses (or pulsed laser light) and receives the reflected light pulses using a light sensor. The lidar 464 includes an emitter that emits light waves via use of a light source and can include various circuitry and/or electronic components that enable adjusting characteristics of the generated light waves or pulses. The lidar 464 can use its processor to compress the raw captured vision data and carry out other operations. Moreover, the vision data captured by the lidar 464 can be image data that is represented in a pixel array (or other similar visual representation) and can thus be considered an image sensor. The lidar 464 can capture static lidar images and/or lidar image or video streams.

Each of the lidar(s) 464 and each of the radar(s) 462 can be attached to the vehicle at different locations, and can include a field of view of a particular area, such as a forward-facing field of view, a rear-facing field of view, and/or a side-facing field of view. The lidar(s) 464 and/or the radar(s) 462 can be used to provide environmental information to the vehicle, such as the location of the roads, vehicles, pedestrians, other roadway objects, etc. This sensor data from the lidar(s) 464 and/or the radar(s) 462 can be used to track another vehicle, such as the leader vehicle 12. The sensor data can thus provide information usable by the follower vehicle 14′ for following (or navigating to) the leader vehicle 12 through use of autonomous vehicle (AV) features or functionality.

With reference back to FIG. 5, the method 300 begins with step 310, wherein a determination to follow the leader vehicle is made. In one embodiment, this determination can be made in response to receiving a vehicle trip start indicator. Also, in some embodiments, this determination can be made in response to user input from a user that is received at a follower vehicle device, such as through receiving input via the vehicle-user interfaces 450-454 and/or via HMIs at the second personal mobile device 94. For example, in one embodiment, the follower vehicle 14′ can include a camera that captures image data of an area in front of the vehicle. The follower vehicle 14′ can display this image data on touchscreen display 450, and then a user can touch a portion of the image data as displayed on the touchscreen display 450. The follower vehicle 14′ can then identify a vehicle corresponding to the portion of the image data touched by the user, and then can determine to follow this vehicle, which can then be considered be the leader vehicle. In another embodiment, the user can select a “FOLLOW CAR” option or button that informs the follower vehicle 14′ to follow the vehicle presently in front of the follower vehicle 14′. The method 300 continues to step 320.

In step 320, the leader vehicle location is determined. In in at least one embodiment, the leader vehicle location is determined through use of the radar(s) 462 and/or the lidar(s) 464. For example, radar signals obtained by the radar(s) 462 can be used to determine the azimuth angle and the range between the follower vehicle 14′ and the leader vehicle 12. This azimuth angle and range information can then be used to determine the leader vehicle location relative to the follower vehicle 14′. In some scenarios, the leader vehicle 12 may not be in the line of sight, the range, or otherwise observable by the radar(s) 462, the lidar(s) 464, or other vehicle sensors such that the leader vehicle location cannot be determined through use of these sensors. In such a case, the method 300 can proceed to step 350. However, in other embodiments, instead of proceeding to step 350 when the leader vehicle location cannot be determined through use of these sensors of the follower vehicle 14′, the follower vehicle 14′ can use other means to obtain the leader vehicle location, such as through receiving the leader vehicle location (e.g., a GNSS location) from a leader vehicle device, from the backend facility 80, and/or from the remote computer(s) 78. When the leader vehicle location is determined, the method 300 continues to step 330.

In step 330, the AV control unit is used to drive (or propel) the follower vehicle toward the leader vehicle so as to follow the leader vehicle. The AV control unit 460 of the follower vehicle 14′ can use the leader vehicle location, other information contained within the sensor data of the radar(s) 462 and/or the lidar(s) 464, other sensor data (e.g., wheel speed sensors, accelerometers), GNSS data obtained by the GNSS receiver 422, and/or geographical roadway data to determine one or more trajectories. The trajectories can then be used to determine one or more control signals or commands to send to various vehicle components so as to cause the follower vehicle 14′ to travel according to the trajectories. For example, a control single can be sent to a throttle of the vehicle, to the ECM 426, to a braking control device, to a steering control device, etc. The method then continues to step 340.

In step 340, a determination as to whether the vehicle trip is still ongoing is made.

This step is similar to step 270 of the method 200, and that discussion above is incorporated herein. In one embodiment, a user of the follower vehicle 14′ (or a follower vehicle device) can select a “STOP FOLLOWING” option presented by a GUI, for example. The method 300 continues to step 320 until it is determined that the vehicle trip is not ongoing. When it is determined that the vehicle trip is not ongoing, the method 300 continues to step 350.

In step 350, the AV control unit is used to drive (or propel) the follower vehicle to a side of the road or other stopping location, and then to stop the follower vehicle in the stopping location. This step can use the GNSS receiver 422 along with geographical roadway data so as to determine the stopping location, as well as to determine one or more trajectories used for driving the follower vehicle 14′ to the stopping location. Once at the stopping location, the follower vehicle 14′ can be stopped and/or placed into park. Also, in some embodiments, the emergency flashers can be activated, a message can be presented using the vehicle-user interfaces (or HMIs of the second personal mobile device 94), or other remedial measure taken. As another example of a remedial measure, a call can automatically be placed to a leader vehicle device and/or a message can be sent to a leader vehicle device. In some embodiments, once the leader vehicle location is determined, the method can proceed back to step 320. Or, the method 300 can then end.

In some embodiments, the user can use a participating vehicle device to specify a vehicle trip name, participant names (which can include the names of the participating users, the participating vehicles, or other name provided by the user), a vehicle start location, a vehicle end location, and/or other information pertaining to the vehicle trip. In some embodiments where a destination is specified prior to the trip, the leader vehicle can be provided navigation instructions or other navigation information from a remote computer, and this information can be displayed on display 50 for the leader vehicle. In one embodiment, this navigation information can be displayed as a geographical map that includes roads.

In one embodiment, the follower vehicle device (or another follower vehicle device) can obtain a follower vehicle location, which is the location of one or more of the follower vehicle devices (e.g., a GNSS location using the GNSS receiver 122/422 or a GNSS receiver of the second personal mobile device 94), and then this follower vehicle location can be sent to a remote facility, such as the same remote facility that receives the leader vehicle location (see step 250). The follower vehicle location can also be sent to the leader vehicle device (or another leader vehicle device). A warning or message can be presented to the user at the leader vehicle device when it is determined that the leader vehicle is more than a predetermined distance away from the follower vehicle. Also, in one embodiment, a geographical map can be displayed on a display (e.g., display 50) of the vehicle electronics 20 of the leader vehicle 12, and may include navigation information (e.g., navigation instructions to a location) as discussed above. This geographical map can also include a follower vehicle location indicator that indicates the last received follower vehicle location, or other follower vehicle location(s), such as those that are presented as waypoints.

Although the illustrated embodiments discussed above mostly refer to a single follower vehicle, it should be appreciated that the method and/or system can be used with a plurality of follower vehicles that are participating in a single or common vehicle trip. In some embodiments where there are a plurality of follower vehicles, the step 210 can include establishing a communication link between the leader vehicle and each of the follower vehicles. This communication link can be established between a first follower vehicle and the leader vehicle by using those techniques discussed above in step 210, and/or may be established by forming a communication link between a first follower vehicle and a second follower vehicle that already has a communication link with the leader vehicle. The first follower vehicle can thus be said to be (indirectly) communicatively linked to the leader vehicle by virtue of the communication links between the first follower vehicle and the second follower vehicle and between the second follower vehicle and the leader vehicle. This chaining of communication links can be carried out such that any number of intervening follower vehicle devices can be used to (indirectly) communicatively link other follower vehicle(s) to the leader vehicle.

In some embodiments, the dynamic vehicle navigation information can include one or more waypoints that direct the follower vehicle toward the leader vehicle location. In some embodiments, the waypoints can be leader vehicle location(s), or may be based on the leader vehicle location(s) so that the waypoints direct the follower vehicle device along the same or a similar route or path to the leader vehicle. This may be desirable when the leader vehicle location is far away from the follower vehicle, and/or when a plurality of follower vehicles are following each other with the leader vehicle defining the path of the vehicle trip. In one embodiment, the follower vehicle device can be provided dynamic vehicle navigation information that is based on the leader vehicle location, but that directs the follower vehicle (or follower vehicle device) to a path or route that is at least partly different from the route of the leader vehicle. For example, when the follower vehicle falls behind the leader vehicle to a certain degree (e.g., over a threshold amount of distance or travel time), the follower vehicle can be provided directions and/or navigation instructions that are chosen so as to decrease the separation (e.g., in time and/or space) between the follower vehicle and the leader vehicle. Also, in one embodiment, the follower vehicle device can be provided directions (e.g., a waypoint) or route information (e.g., navigation instructions) that direct the follower vehicle to not pass the leader vehicle and/or to orient the follower vehicle in the same or similar manner as the leader vehicle—for example, the dynamic vehicle navigation information can direct the follower vehicle to arrive at the same intersection as the leader vehicle as well as to arrive at the intersection via the same road and in (or facing) the same direction as the leader vehicle.

In embodiments in which there are a plurality of follower vehicles, the order of the follower vehicles can be defined by the users (or automatically based on the locations of the follower vehicles when the vehicle trip is starting). In such embodiments, a first one of the follower vehicles can be provided the dynamic vehicle navigation information, which can be based on a location of the other follower vehicle(s) that are ahead (i.e., those further along in the vehicle trip) of the first follower vehicle. For example, the follower vehicle location(s) of those other follower vehicles can be provided to the first follower vehicle as a waypoint (i.e., an example of dynamic vehicle navigation information) and/or otherwise used to direct the first follower vehicle according to the vehicle trip, which is ultimately based on the leader vehicle location.

The follower vehicle can include one or more onboard systems for accepting the navigation inputs (e.g., leader vehicle location) provided by the remote computer system (which was received by the remote computer system from the leader vehicle or other leader vehicle device). The navigation inputs can be used by the follower vehicle (or other follower vehicle device) to obtain instructions (e.g., dynamic vehicle navigation information) for navigating to the human driver (or, in the case of an autonomous vehicle, to an AV systems navigation unit included on the follower vehicle). The navigation system of the follower vehicle is thus able to react to the motion of the leader vehicle and provide directions to enable the follower vehicle to continue following the leader vehicle, at least according to some embodiments.

In one embodiment, the leader vehicle and the follower vehicle(s) can be associated by the leader vehicle and the follower vehicle(s) exchanging a secure “token” (e.g., a unique code) exchanged using remote communications (e.g., an SMS message or email) or an in-person (or local) exchange, such as where the leader vehicle calls out (or otherwise provides) the token that can then be heard (or otherwise obtained) by the user of the follower vehicle and entered into the vehicle user application of the second personal mobile device (or other follower vehicle device). In one embodiment, the process or method to authenticate and exchange this “token” can be done verbally, or over a telephone call, or over an email or over a secure exchange of mobile phone data (such as NFC tap, Bluetooth, etc.). In some embodiments, the intent is to exchange data not reproducible outside of the agreed upon exchange.

In at least some embodiments, the association depends on this “token” to be the source of truth that represents a leader vehicle account and a follower vehicle account on a remote computer system (e.g., backend facility 80) having been associated through the exchange of the token. In one embodiment, the token can be generated by the vehicle user application of the first personal mobile device (or other leader vehicle device), or may be provided to the leader vehicle device from the backend facility, which can generate the token at least in some embodiments. The token and any data representing that the token has been exchanged can serve as the authentication in the remote computer system(s) that are associated with both the leader and follower vehicles. In some embodiments, this authentication thus causes the follower vehicle(s) (or follower vehicle device(s)) to be entitled to receive the leader vehicle location for an agreed period time, such as a time period for the vehicle trip.

Also, it should be appreciated that any technically-feasible combination of the steps 210-280 of the method 200 can be used as a part of the method 300, and any technically-feasible combination of the steps 310-350 of the method 300 can be used as a part of the method 200. For example, the method 300 can include a step of establishing a communication link between a leader vehicle device and a follower vehicle device (see step 210 of the method 200), and/or a step of terminating the communication link between the leader vehicle device and the follower vehicle device (see step 280 of the method 200).

In one embodiment, the method 200, the method 300, and/or step(s) or parts thereof can be implemented in one or more computer programs (or “applications”, or “scripts”) embodied in one or more computer readable mediums and including instructions usable (e.g., executable) by one or more processors of the one or more computers of one or more systems. The computer program(s) may include one or more software programs comprised of program instructions in source code, object code, executable code, or other formats. In one embodiment, any one or more of the computer program(s) can include one or more firmware programs and/or hardware description language (HDL) files. Furthermore, the computer program(s) can each be associated with any program related data and, in some embodiments, the computer program(s) can be packaged with the program related data. The program related data may include data structures, look-up tables, configuration files, certificates, or other relevant data represented in any other suitable format. The program instructions may include program modules, routines, programs, functions, procedures, methods, objects, components, and/or the like. The computer program(s) can be executed on one or more computers, such as on multiple computers that are in communication with one another.

The computer program(s), including the vehicle user application, can be embodied on computer readable media (e.g., memory 38 of the leader vehicle 12, memory 138 or 438 of the follower vehicle 14 or 14′, other vehicle memory, memory of the remote computer(s) 78, memory of the backend facility 80 including those of servers 82, a combination thereof), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

What is claimed is:

1. A method of providing dynamic vehicle navigation information to a follower vehicle based on a leader vehicle location of a leader vehicle, comprising the steps of:
establishing a communication link between a first personal mobile device and a second personal mobile device, wherein the first personal mobile device is associated with the leader vehicle and the second personal mobile device is associated with the follower vehicle;
after establishing the communication link between the first personal mobile device and the second personal mobile device, obtaining leader vehicle identification information and follower vehicle identification information, wherein the leader vehicle identification information is used to identify a vehicle as the leader vehicle, and wherein the and follower vehicle identification information is used to identify a vehicle as the follower vehicle;
periodically obtaining the leader vehicle location of the leader vehicle; and
causing a follower vehicle device to be periodically provided dynamic vehicle navigation information based on the leader vehicle location, wherein the dynamic vehicle navigation information includes directions so that the follower vehicle at least partially follows the leader vehicle.

2. The method of claim 1, wherein the dynamic vehicle navigation is provided to the follower vehicle during a vehicle trip in which the leader vehicle and the follower vehicle are participating vehicles, wherein the periodically obtaining step and the causing step are carried out periodically until it is determined that the vehicle trip has ended.

3. The method of claim 1, wherein the method further comprises sending the leader vehicle location to the follower vehicle device, wherein the follower vehicle device is configured to display a leader vehicle location indicator on a geographical map of the surrounding area of the follower vehicle device so as to enable a user at the follower vehicle device to track the leader vehicle.

4. The method of claim 1, wherein the step of obtaining the leader vehicle location comprises obtaining the leader vehicle location from the first personal mobile device or from a leader vehicle device installed in the leader vehicle, and wherein the follower vehicle device is the second personal mobile device or is a different device installed in the follower vehicle.

5. The method of claim 4, wherein the first personal mobile device includes a first vehicle user application and the second personal mobile device includes a second vehicle user application, and wherein the first vehicle user application and/or the second vehicle user application provide a graphical user interface (GUI) that enables a user to search for other devices participating or seeking to participate in a vehicle trip.

6. The method of claim 5, wherein the user provides input into the first vehicle user application and/or the second vehicle user application, and wherein the input specifies which vehicle is to be the leader vehicle.

7. The method of claim 1, wherein the leader vehicle location is periodically obtained at the leader vehicle using a global navigation satellite system (GNSS) receiver and then sent to a first remote computer from the vehicle using a wireless carrier system.

8. The method of claim 7, wherein the leader vehicle location is used by a second remote computer to obtain the dynamic vehicle navigation information, and wherein the second remote computer is either the first remote computer or another remote computer.

9. The method of claim 8, wherein the leader vehicle location is sent from the first remote computer to the follower vehicle device, wherein, after receiving the leader vehicle location, the follower vehicle device sends the leader vehicle location to the second remote computer, and wherein, in response to receiving the leader vehicle location, the second remote computer sends the dynamic vehicle navigation information to the follower vehicle device.

10. The method of claim 1, wherein the follower vehicle is an autonomous vehicle (AV), and wherein the follower vehicle uses the dynamic vehicle navigation information to carry out one or more AV functions so as to cause the follower vehicle to follow the leader vehicle location based on the dynamic vehicle navigation information.

11. The method of claim 10, wherein the follower vehicle includes one or more onboard vehicle sensors in the form of either a radar or lidar, wherein the follower vehicle captures sensor data from the one or more onboard vehicle sensors, wherein the follower vehicle uses the sensor data to identify the leader vehicle and to determine the position of the leader vehicle relative to the follower vehicle, and wherein the position of the leader vehicle relative to the follower vehicle is used to carry out at least one of the one or more AV functions.

12. The method of claim 11, wherein the follower vehicle determines one or more trajectories based on the dynamic vehicle navigation information, and wherein the follower vehicle determines at least one of the one or more of AV functions based on the trajectories.

13. A method of providing dynamic vehicle navigation information to a follower vehicle based on a leader vehicle location of a leader vehicle, comprising the steps of:
establishing a communication link between a first personal mobile device and a second personal mobile vehicle device, wherein the first personal mobile device includes a first vehicle user application and the second personal mobile device includes a second vehicle user application, and wherein the first vehicle user application and/or the second vehicle user application provide a graphical user interface (GUI) that enables a user to search for other devices participating or seeking to participate in a vehicle trip;
obtaining input from one or more users of the first vehicle user application and/or the second vehicle user application, wherein the input specifies a first vehicle to be the leader vehicle and the input specifies a second vehicle to be the follower vehicle;
sending the input to a first remote computer from the first vehicle user application and/or the second vehicle user application, wherein the remote computer causes the leader vehicle to periodically send the leader vehicle location to a second remote computer, wherein the second remote computer is either the first remote computer or another remote computer; and
causing a follower vehicle device to be periodically provided dynamic vehicle navigation information based on the leader vehicle location, wherein the dynamic vehicle navigation information includes directions so that the follower vehicle at least partially follows the leader vehicle.

14. The method of claim 13, wherein the first vehicle user application permits a first user to login to a first account associated with the first vehicle and the second vehicle user application permits a second user to login to a second account associated with the second vehicle.

15. The method of claim 14, wherein the first vehicle user application and the second vehicle user application identify each participating vehicle of a plurality of participating vehicles, and wherein the plurality of participating vehicles includes the leader vehicle and the follower vehicle.

16. The method of claim 15, wherein the plurality of participating vehicles includes a plurality of follower vehicles, and wherein the causing step includes causing each of the plurality of follower vehicles to be periodically provided the dynamic vehicle navigation information based on the leader vehicle location.

17. The method of claim 16, wherein, for each of the follower vehicles, the dynamic vehicle navigation information includes providing a series of waypoints based on the follower vehicle location and the leader vehicle location.

18. A method of providing dynamic vehicle navigation information to a follower vehicle based on a leader vehicle location of a leader vehicle, comprising the steps of:
establishing a communication link between a first personal mobile device and a second personal mobile vehicle device, wherein the first personal mobile device includes a first vehicle user application and the second personal mobile device includes a second vehicle user application, and wherein the first vehicle user application and/or the second vehicle user application provide a graphical user interface (GUI) that enables a user to search for other devices participating or seeking to participate in a vehicle trip;
obtaining input from one or more users of the first vehicle user application and/or the second vehicle user application, wherein the input specifies a first vehicle to be the leader vehicle and the input specifies a second vehicle to be the follower vehicle;
sending the input to a first remote computer from the first vehicle user application and/or the second vehicle user application, wherein the remote computer causes the leader vehicle to periodically send the leader vehicle location to a second remote computer, wherein the second remote computer is either the first remote computer or another remote computer; and
causing the follower vehicle to autonomously follow the leader vehicle based on sensor data from one or more autonomous vehicle (AV) sensors, wherein the follower vehicle follows the leader vehicle by tracking the leader vehicle using the sensor data to obtain the leader vehicle location, wherein the sensor data pertains to an area in front of the follower vehicle, and wherein the sensor data is used to obtain dynamic vehicle navigation information that then is used by the follower vehicle for carrying out one or more AV functions so as to at least partially follow the leader vehicle.

19. The method of claim 18, wherein the follower vehicle determines one or more trajectories based on the sensor data, and wherein the follower vehicle determines at least one of the one or more of AV functions based on the trajectories.

20. The method of claim 18, wherein the follower vehicle is periodically provided a global navigation satellite system (GNSS) location of the leader vehicle, and wherein the dynamic vehicle navigation information or other dynamic vehicle navigation information is obtained based on the GNSS location of the leader vehicle.
